(19) United States
(12) Patent Application Publication
(10) Pub. No.: US 2026/0127753 A1
(43) Pub. Date: May 7, 2026

(54) GENERATING DEPTH INFORMATION IN AUTOMOTIVE IMAGING SYSTEMS

(71) Applicant: QUALCOMM Incorporated, San Diego, CA (US)

(72) Inventor: Louis Joseph Kerofsky, San Diego, CA (US)

(21) Appl. No.: 18/940,227

(22) Filed: Nov. 7, 2024

(51) Int. Cl. G06T 7/50; G06T 7/20; H04N 23/695

(52) U.S. Cl. CPC G06T 7/50; G06T 7/20; H04N 23/695; G06T 2207/20228

(57) ABSTRACT

A device for image processing includes: one or more memories; and processing circuitry coupled to the one or more memories, wherein the processing circuitry is configured to: receive a first image captured with a first camera and a second image captured with a second camera; determine a rotation component and a translation component of the first camera based on one or more of images captured with the first camera or one or more sensors; determine a corrected image from the first image based on the rotation component; generate another image from the second image; and generate depth information based on pixels in the corrected image and corresponding pixels in the other image and the translation component.

### TECHNICAL FIELD

The disclosure relates to image processing including depth data generation.

### BACKGROUND

Example techniques to generate depth information include utilizing two images captured from two different cameras for the same image content. Processing circuitry may determine corresponding pixels in the two images, and disparity between the locations of the corresponding pixels in the two images. Based on the disparity, the processing circuitry may determine depth information (e.g., how far away the objects are from the cameras).

### SUMMARY

In general, this disclosure describes techniques for accounting for rotation and translation movement of cameras of a camera pair for generating depth information, as well as accounting for a time difference between when corresponding pixels are captured due to the use of a rolling shutter. For generating depth information, processing circuitry may be configured to determine corresponding pixels (e.g., pixels for the same physical object captured by the images) of two images that capture the same image content, and disparity between these corresponding pixels. However, the corresponding pixels in the two images may not be captured at the same time due to rolling shutter. Moreover, the position of the corresponding pixels in the two images may be changed if there is movement of the cameras. Together, the timing difference between when corresponding pixels are captured due to rolling shutter, and the movement of the cameras (e.g., rotational or translational movement) may result in generating incorrect depth information.

In one or more examples, processing circuitry may be configured to perform per-frame operations that compensate for the rotational changes in the images used for generating depth information due to rolling shutter and camera movement. The processing circuitry may be configured to perform per-pixel operations that compensate for the translational changes in the images used for generating depth information due to rolling shutter and camera movement. In this manner, the generated depth information may more accurately indicate the depth of objects as compared to other techniques.

In one example, the disclosure describes a device for image processing, comprising: one or more memories; and processing circuitry coupled to the one or more memories, wherein the processing circuitry is configured to: receive a first image captured with a first camera and a second image captured with a second camera; determine a rotation component and a translation component of the first camera based on one or more of images captured with the first camera or one or more sensors; determine a corrected image from the first image based on the rotation component; generate another image from the second image; and generate depth information based on pixels in the corrected image and corresponding pixels in the other image and the translation component.

In one example, the disclosure describes a method of image processing, the method comprising: receiving a first image captured with a first camera and a second image captured with a second camera; determining a rotation component and a translation component of the first camera based on one or more of images captured with the first camera or one or more sensors; determining a corrected image from the first image based on the rotation component; generating another image from the second image; and generating depth information based on pixels in the corrected image and corresponding pixels in the other image and the translation component.

In one example, the disclosure describes one or more computer-readable storage media storing instructions thereon that when executed cause one or more processors to: receive a first image captured with a first camera and a second image captured with a second camera; determine a rotation component and a translation component of the first camera based on one or more of images captured with the first camera or one or more sensors; determine a corrected image from the first image based on the rotation component; generate another image from the second image; and generate depth information based on pixels in the corrected image and corresponding pixels in the other image and the translation component.

The details of one or more examples are set forth in the accompanying drawings and the description below. Other features, objects, and advantages will be apparent from the description, drawings, and claims.

### BRIEF DESCRIPTION OF DRAWINGS

FIG. 1 is a diagram of an example vehicle in accordance with the techniques of this disclosure for object detection in accordance with one or more examples described in this disclosure.

FIGS. 2A and 2B illustrate examples of images captured with cameras.

FIG. 3 is a block diagram of a device configured to perform one or more of the example techniques described in this disclosure.

FIG. 4 is a flowchart illustrating a method of image processing according to one or more example techniques described in this disclosure.

FIG. 5 is a flowchart illustrating another method of image processing according to one or more example techniques described in this disclosure.

FIG. 6 is a flowchart illustrating another method of image processing according to one or more example techniques described in this disclosure.

FIG. 7 is a flowchart illustrating another method of image processing according to one or more example techniques described in this disclosure.

FIGS. 8A and 8B are conceptual diagram illustrating a vehicle moving in a circle for determining translational component.

### DETAILED DESCRIPTION

An example technique to generate depth information (e.g., of objects in an image) is to capture two images from two different cameras, identify corresponding pixels in the two images, and determine the disparity of the corresponding pixels. Corresponding pixels refer to pixels that are capturing the same object, and disparity refers to difference in locations of the corresponding pixels in respective images. For instance, the two cameras are separated by a baseline distance. In such examples, pixels for the same object appear at different locations (e.g., horizontally displaced relative to one another) in the images. This difference in locations is typically referred to as disparity.

This disparity is due to the depth of the object and the baseline distance, and can also be due to the focal length of the cameras. For instance, corresponding pixels for nearby objects in the images may have less disparity compared to corresponding pixels for more distant objects. By determining the disparity, baseline distance, and focal length, processing circuitry may be configured to determine depth information, including depth information related to objects in the scene (e.g., how distant the object is that is represented by the corresponding pixels in the images).

That is, a first camera and a second camera form a camera pair for depth estimation by triangulating corresponding pixels in overlapping views of a first image captured with the first camera and a second image captured with the second camera. Using camera-based depth may be useful in various techniques, such as augmenting or replacing of other depth sensors, such as radar or LiDAR. As an example, generating depth information may be used for vehicle control, where the depth information may augment or replace depth information generated using radar or LiDAR. Depth information may be used in other scenarios as well as such a robotics.

While generating depth information using disparity and baseline distance works well in many instances, there may be limitations to generating depth information using such techniques because such techniques assume no movement and same capture time of pixels. However, when the first and second cameras are capturing pixels are different times, and when there is movement of the device (e.g., where the device is a vehicle), the generated depth information from some techniques is inaccurate.

For instance, the first and/or second camera may use a rolling shutter. Rolling shutter cameras are commonly used and have the property that pixels are not captured at the same time instant in all parts of the frame. A rolling shutter is a method used in digital imaging sensors to capture an image by exposing different parts of the sensor of the camera to light in a sequential, rolling manner. Instead of exposing the entire sensor to light at the same instant, as with a global shutter, the rolling shutter reads and records the image data line by line or row by row. This method is common in many CMOS sensors found in consumer cameras, smartphones, and video devices.

When an image is captured, the rows or columns of a sensor of the camera are exposed to light one after the other in quick succession. The exposure starts at one end of the sensor (e.g., the top) and moves down or across until the entire sensor has been exposed. The readout of each row is synchronized with its exposure, so by the time the last row is exposed, the first row has already been read out.

Furthermore, both translation and rotational camera motion interact with rectification used to create images for determining corresponding pixels, where traditional techniques assume camera locations are fixed. For instance, a rotation component of the movement of the cameras refers to movement in the direction that the camera is pointing. A translation component of the movement of the camera refers to movement in a position of the camera.

The rotation and translation components may be different in the two cameras because of rolling shutter and movement. For example, assume a first camera is front-facing and closer to the driver side of the vehicle, and a second camera is also front-facing but closer to the passenger side of the vehicle, and assume that the vehicle is curving as a turn in the direction of the driver side (e.g., left in some countries, and right in other countries). In this case, the amount of translation for the first camera and the second camera may be different. Moreover, if there is rolling shutter, then the time difference for when corresponding pixels are captured may be different, especially if there is movement.

Since rolling shutter and camera movement can impact accuracy of the generated depth information, some techniques that assume no movement and/or rolling shutter or fail to accurately address movement and/or rolling shutter result in inaccurate depth information. In accordance with one or more examples described in this disclosure, processing circuitry may be configured to utilize information about time differences when pixels are captured, and use the rotation component and translation component (e.g., as separate components) to compensate for the rotation and the translation.

For instance, on a per-frame basis, the processing circuitry may use the rotation component (e.g., which includes rotational speed of the vehicle) and the time difference between when pixels are captured to rectify the images to correct for the rotational change. The processing circuitry may determine corresponding pixels in these rotationally corrected images. On a per-pixel basis, the processing circuitry may use the translation component (e.g., which include translation speed of the vehicle) and the time difference between when pixels are captured to rectify the images to update a baseline distance between the cameras. The processing circuitry may then use the corresponding pixels from the rotationally corrected images and the updated baseline distance to generate the depth information.

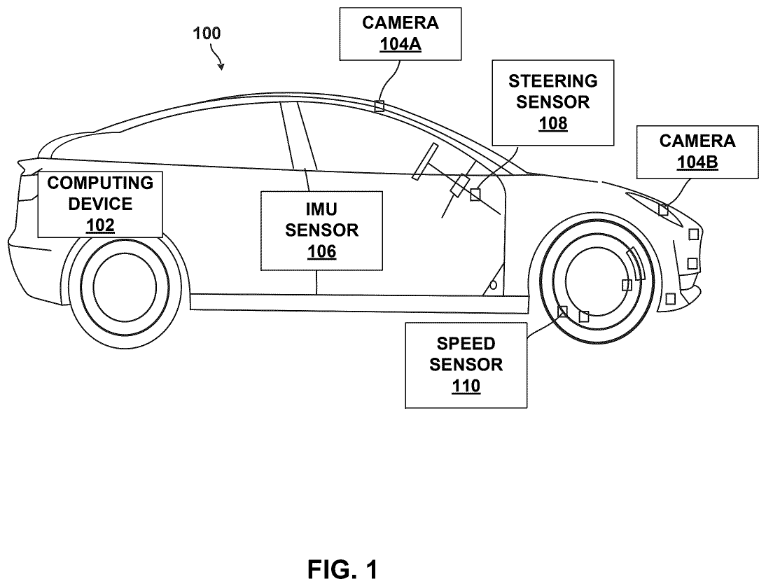

FIG. 1 shows an example vehicle 100. Vehicle 100 in the example shown may comprise a passenger vehicle such as a car or truck that can accommodate a human driver and/or human passengers. Other examples of vehicle 100 include robots or other devices that move. For ease of illustration and description, vehicle 100 is described with respect to a passenger vehicle.

In one example, vehicle 100 may comprise an autonomous vehicle, semi-autonomous vehicle and/or an advanced driver assistance system (ADAS). Vehicle 100 may be referred to as an “ego” vehicle. Vehicle 100 may include a vehicle body suspended on a chassis, in this example comprised of four wheels and associated axles. A propulsion system such as an internal combustion engine, hybrid electric power plant, or even all-electric engine may be connected to drive some or all of the wheels via a drive train, which may include a transmission (not shown). A steering wheel may be used to steer some or all of the wheels to direct vehicle 100 along a desired path when the propulsion system is operating and engaged to propel the vehicle 100. A steering wheel or the like may be optional for Level 5 implementations. Computing device 102 may provide autonomous capabilities in response to signals continuously provided in real-time from an array of sensors, as described more fully below.

Computing device 102 may be one or more onboard computers that may be configured to perform deep learning and/or artificial intelligence functionality and output autonomous operation commands to self-drive vehicle 100 and/or assist the human vehicle driver in driving. Computing device 102 may send command signals to operate the vehicle brakes via one or more braking actuators, operate steering mechanism via a steering actuator, and operate the propulsion system which also receives an accelerator/throttle actuation signal. Actuation may be performed by methods known to persons of ordinary skill in the art, with signals typically sent via the Controller Area Network data interface (“CAN bus”)—a network inside modern cars used to control brakes, acceleration, steering, windshield wipers, and the like. The CAN bus may be configured to have dozens of nodes, each with its own unique identifier (CAN ID). The bus may be read to find steering wheel angle, ground speed, engine RPM, button positions, and other vehicle status indicators. The functional safety level for a CAN bus interface is typically Automotive Safety Integrity Level (ASIL) B. Other protocols may be used for communicating within a vehicle, including FlexRay and Ethernet.

In one example, an actuation controller on vehicle 100 may include dedicated hardware and software, allowing control of throttle, brake, steering, and shifting. The hardware may provide a bridge between the vehicle's CAN bus and computing device 102, forwarding vehicle data to computing device 102 including the turn signal, wheel speed, acceleration, pitch, roll, yaw, Global Positioning System (“GPS”) data, tire pressure, fuel level, sonar, brake torque, and others. Similar actuation controllers may be configured for any other make and type of vehicle, including special-purpose patrol and security cars, robo-taxis, long-haul trucks including tractor-trailer configurations, tiller trucks, agricultural vehicles, industrial vehicles, and buses.

In accordance with one or more examples described in this disclosure, computing device 102 may be configured to generate depth information (e.g., real-time depth information) that computing device 102 or another device may use for controlling vehicle 100 or for providing alarms (e.g., if vehicle 100 is too close to an object). To generate the depth information, computing device 102 may receive images captured with camera 104A and camera 104B. That is, computing device 102 may receive a first image captured with a first camera (e.g., camera 104A) and a second image captured with a second camera (e.g., camera 104B), the first camera and the second camera forming a camera pair for depth estimation.

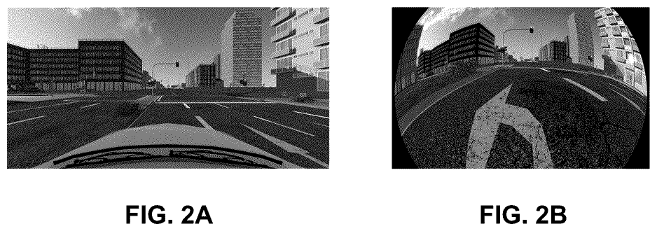

Camera 104A and camera 104B may be the same type of camera or may be different types of cameras. As one example, both camera 104A and camera 104B may be cameras with a flat lens, or both camera 104A and camera 104B may be cameras with a fisheye lens. As another example, camera 104A may be a camera with a flat lens, and camera 104B may be a camera with a fisheye lens. FIGS. 2A and 2B illustrate examples of images captured with cameras. For instance, FIG. 2A illustrates an example of an image captured with camera 104A, where camera 104A includes a flat lens, and FIG. 2B illustrates an example of an image captured with camera 104B, where camera 104B includes a fisheye lens. The above are some examples of camera 104A and camera 104B, but the example techniques are not limited to those examples.

Computing device 102 may be configured to use details of camera timing (e.g., when pixels were captured) and movement (e.g., motion) of cameras 104A and 104B to modify the images from camera 104A and 104B, and use the modified images for generating the depth information. The movement of each of cameras 104A and 104B may be separated out into a rotation component and a translation component. A rotation component of the movement of camera 104A or camera 104B refers to movement in the direction that camera 104A or camera 104B is pointing. A translation component of the movement of camera 104A or camera 104B refers to movement in a position of camera 104A or camera 104B.

In one or more examples, the rotation of cameras 104A and 104B may be identical but the translations may differ slightly. A camera on the center may translate more that the camera on the right side if the vehicle turns right. The rotations may be the same. Although the rotations in 3D world coordinates may be the same, the impact on the camera pixel optical flow, as described in more detaill, may differ if the cameras have different orientation.

The rotation component and the translation component may include a rotational speed and a translational speed, respectively, as well as actual movement information. The rotational component may be identical to the rotation of the vehicle 100 but the translation components may differ when the vehicle 100 turns due to the location of cameras 104A and 104B on the vehicle 100. For instance, the rotation component of camera 104A may include information about how many degrees camera 104A rotated, and the speed at which the rotation occurred (e.g., rotational speed). The translation component of camera 104A may include information about how far camera 104A moved (e.g., left, right, forward, or backward), and the speed at which the translation occurred (e.g., translational speed).

There may be various ways to determine the movement, including the rotation and translation components. As one example, computing device 102 may determine the rotation component and the translation component using video odometry techniques that are known. As another example, computing device 102 may determine the rotation component and the translation component using speed and steering wheel angle of vehicle 100 that includes camera 104A and camera 104B. For example, steering sensor 108 may indicate the steering wheel angle, while speed sensor 110 may indicate the speed.

As another example, vehicle 100 includes inertial measurement unit (IMU) 106. IMU 106 may be configured to generate speed and movement information that computing device 102 receives. In some examples, the rotation component of camera 104A and camera 104B may be the same as the rotation component of IMU 106. However, when camera 104A and camera 104B are offset relative to IMU 106, the translation component of camera 104A and camera 104B and IMU 106 may differ. To compensate for this difference, computing device 102 may use the rotation component along with the offset to determine a translation offset that computing device 102 adds to the translation component from IMU 106 to determine the translation component of camera 104A and camera 104B. The above are some example techniques to determine the rotation component and the translation component, but the techniques are not limited to such examples.

In this manner, computing device 102 may determine a rotation component and a translation component of camera 104A and camera 104B such as based one or more images captured with camera 104A or camera 104B or one or more sensors such as IMU 106 (e.g., while camera 104A or camera 104B is in motion). In one or more examples, computing device 102 may determine a corrected image (e.g., rotation corrected image) from the first image (e.g., from camera 104A) based on the rotation component of the camera 104A, and determine a corrected image (e.g., rotation corrected image) from the second image (e.g., from camera 104B) based on the rotation component of the camera 104B. The corrected images may compensate for the rotation movement due to vehicle 100 moving and the rolling shutter.

In one or more examples, the computing device 102 may determine a corrected image based on initial factors determined at an initial period (e.g., after manufacturing of vehicle 100, at the beginning of when vehicle 100 is put to use, etc.). During the initial period, vehicle 100 may not be in motion (e.g., zero-motion) or amount of motion may be less than some threshold. One example of the initial factor may include information indicative of a time difference between when pixels in the first image (e.g., from camera 104A) and pixels in the second image (e.g., from camera 104B) are captured. Another example of the initial factor may include optical flow information indicative of an amount of pixel rotational movement in images captured with camera 104A or camera 104B for a unit of rotational movement of camera 104A or camera 104B. Computing device 102 may determine a rotational change based on the time difference, the rotational speed, and the optical flow information, and rectify the first image and the second image based on the rotational change to determine the corrected images.

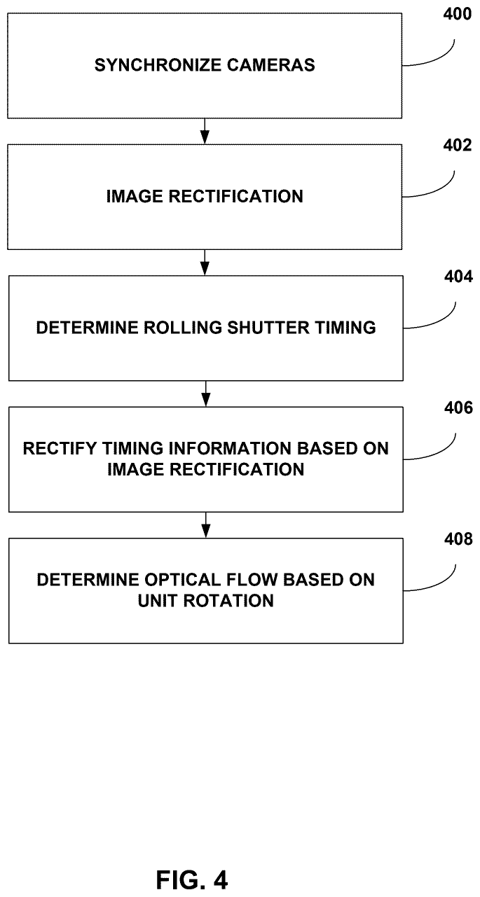

The following describes example techniques for determining the initial factors, during an initial period (e.g., a one-time process done at beginning of vehicle 100 starting). The example techniques for determining the initial factors, during an initial period are also described below, and with respect to FIG. 4.

Computing device 102 may be configured to synchronize timing of when camera 104A and camera 104B are to capture images. For instance, camera 104A and camera 104B may align with the horizon or center of the image, and may synchronize capturing rows of images starting from the same synchronization line.

Each of camera 104A and 104B may capture an image. In examples where the lens of camera 104A and 104B is different, computing device 102 may perform rectification. For instance, referring back to FIGS. 2A and 2B, since camera 104B includes a fisheye lens, in this example, computing device 102 may be configured to flatten out the image so that the rectified image from camera 104B appears in the same image domain as the image from camera 104A. For instance, there may be lens parameters such as how much light bents on a per-pixel or per-region basis, etc. that computing device 102 may use to determine a geometric rectification that computing device 102 uses for image rectification. For instance, computing device 102 may scale pixel coordinates based on a factor, where the factor is based on information of light bending on a per-pixel or per-region basis. There are various known techniques to perform such rectification, and the example techniques are not limited to a particular technique.

Computing device 102 may receive information indicative of a rolling shutter timing. For instance, the rolling shutter timing (e.g., when a row or column of image content is captured) may be preset or dynamically determined. Computing device 102 may use the rolling shutter timing to determine a time when each pixel in the first image (e.g., from camera 104A) is captured and when each pixel in the second image (e.g., from camera 104B) is captured. Based on the rolling shutter timing, computing device 102 may be able to determine a timing difference between when pixels in the first image and the second image are captured.

However, in some examples, computing device 102 may rectify the time information, such as in cases where the lens of camera 104A and camera 104B is different. For instance, assume camera 104B is a fisheye lens like in FIG. 2B, computing device 102 may determine the rolling shutter timing information from camera 104B. After rectification, as described above, where image from camera 104A and image from camera 104B are both in the same image domain (e.g., both are flat images), there may be distortion in the image content. For instance, as part of the rectification, the location of pixels change, and therefore, information of when a particular pixel is captured may need to be updated since the location of that pixel changed.

In one or more examples, computing device 102 may determine the rectified timing information from the rectified images and timing information (e.g., time difference when pixels are captured and/or rolling shutter information). The timing information may be typically given as a time offset for each row from the top of the camera frame. To rectify the timing information, the timing information may be converted to the rectified frame using the same image transformation used for image rectification. As one example, computing device 102 may create an identically sized frame with values that are time offsets, then apply the same geometric rectification, used for image rectification, to determine the time offset for a pixel.

In addition, computing device 102 may determine optical flow information indicative of an amount of pixel rotational movement in images captured with camera 104A and camera 104B. For instance, computing device 102 may determine by how much pixels in the images (e.g., after rectification) rotate for one unit of rotation of camera 104A and camera 104B. As one example, computing device 102 may determine optical flow information offline by starting with a pixel, projecting that into a point in three-dimensional space at any specific distance, rotate the camera one unit and then project back to the camera image to determine where the pixel moves to. For these pure rotations, the resulting pixel motion is the same regardless of the distance in 3D used. A large value of say 100 meter may be used as an example.

In this manner, computing device 102 may determine the optical flow information and the time difference between when pixels in the first image and the second image are captured. Computing device 102 may store such information for later use when generating depth information. For instance, during operation when real-time depth information is needed, computing device 102 may determine a corrected image (e.g., rotation corrected image) from the first image based on the rotation component of camera 104A and a corrected image (e.g., rotation corrected image) from the second image based on the rotation component of camera 104B. To determine such corrected images, computing device 102 may determine a time difference between when pixels in the first image and the second image are captured, as described, and access optical flow information indicative of an amount of pixel rotational movement in images captured with the first camera for a unit of rotational movement of the first camera, as described.

Computing device 102 may determine a rotational change based on the time difference, the rotational speed, and the optical flow information. For instance, the units of rotational speed may be degrees/second, and units of the time difference may be seconds. The units of the optical flow information may amount of rotation per degree. By multiplying the time difference and the rotational speed, the resulting units may be degrees, and multiplying that result by the optical flow information results a rotational change information of how much the images from camera 104A and camera 104B rotated. Computing device 102 may rectify the first image from camera 104A and the second image from camera 104B (e.g., possibly after initial rectification of either or both to bring the images to the same image domain) based on the rotational change to determine a corrected image for camera 104A and a corrected image for camera 104B.

As described above, computing device 102 may generate a corrected image from camera 104A. Computing device 102 may generate another image from camera 104B (e.g., corrected image from camera 104B). Computing device 102 may generate depth information based on pixels in the corrected image from camera 104A and corresponding pixels in the other image generated from the second image (e.g., corrected image from camera 104B) and the translation component. As one example, computing device 102 may determine disparity information based on the pixels in the corrected image and the corresponding pixels in the other image. To generate depth information, computing device 102 may be configured to generate the depth information based on the disparity information and the translation component.

As described above, the depth information is based on the baseline distance. The translational movement and the time difference due to rolling shutter may be considered as effectively changing the baseline distance.

For example, similar to above, computing device 102 may determine a time difference between when pixels in the first image and the second image are captured. Computing device 102 may determine a camera baseline between camera 104A and camera 104B based on the time difference and the translation component (e.g., of one or both camera 104A and camera 104B). For example, computing device 102 may determine a baseline offset based on a multiplication of the translation speed and the time difference. The units of the translation speed may be distance per second, and the units of the time difference may be seconds, and therefore the resulting units of the multiplication of the translation speed and the time difference may be distance. This distance may be a baseline offset that computing device 102 adds to the actual distance between camera 104A and camera 104B to determine the camera baseline. Computing device 102 may generate the depth information based on the disparity information and the camera baseline.

For instance, computing device 102 may use the standard equation of depth information equal ((focal length of camera 104A or camera 104B)*camera baseline) divided by disparity. However, in accordance with one or more examples, the disparity is determined based on corresponding pixels in the corrected images that compensate for the rotation component of the movement of camera 104A and camera 104B, and the camera baseline is determined based on the translation speed and timing difference between when pixels are captured due to rolling shutter.

Computing device 102 may be configured to perform various operations based on the depth information. For example, computing device 102 may be configured to determine an operating parameter based on the depth information. As an example, the operating parameter may be an operating parameter of vehicle 100 that includes first camera 104A and second camera 104B. As one example, computing device 102 may determine a braking parameter such as whether to automatically cause vehicle 100 to brake because the depth information indicates that an object is close by. As another example, computing device 102 may determine a path parameter that indicates a path vehicle 100 should take based on the depth information. For instance, computing device 102 may navigate a path based on how close objects are as determined from the depth information. There may be other operations such as determining whether objects are moving or not, and other such scene analysis.

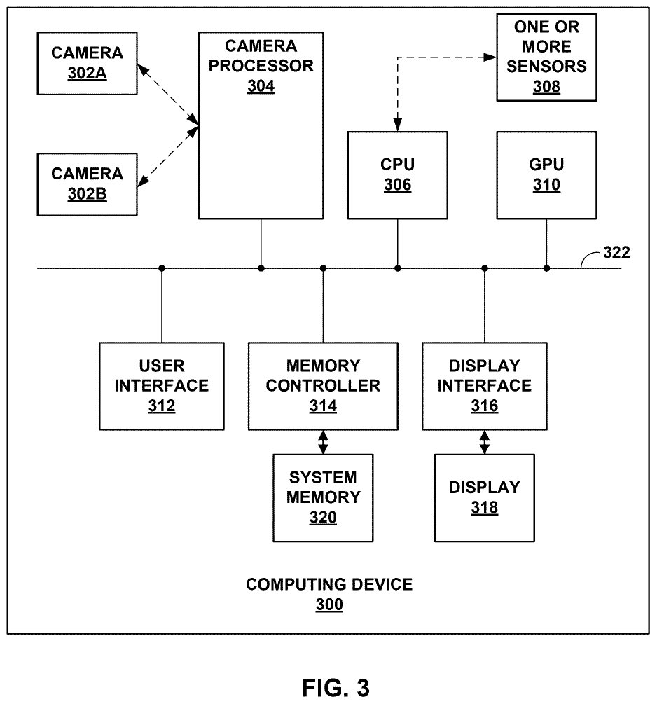

FIG. 3 is a block diagram of a device configured to perform one or more of the example techniques described in this disclosure. One example of computing device 300 of FIG. 3 is computing device 102 of FIG. 1. However, there may be other examples of computing device 300 such as any device that moves having cameras used for depth information generation. Examples of computing device 300 include a laptop, a mobile device such as a tablet computer, a wireless communication device (such as, e.g., a mobile telephone, a cellular telephone, a satellite telephone, and/or a mobile telephone handset).

As illustrated in the example of FIG. 3, computing device 300 includes camera processor 304 that receives images from cameras 302A and 302B. Camera processor 304 is an example of an image signal processor (ISP). Cameras 302A and 302B may be similar to cameras 104A and 104B of FIG. 1. Computing device 300 also includes a central processing unit (CPU) 306 that receives data from one or more sensors 308. Examples of one or more sensors 308 include IMU sensor 106, steering sensor 108, and speed sensor 110, or any other sensors used to determine rotation and translation component of cameras 302A and 302B.

Computing device 300 includes graphical processing unit (GPU) 310, and user interface 312. Memory controller 314 of computing device 300 provides access to system memory 320 of computing device 300. Display interface 316 of computing device 300 that outputs signals that cause graphical data to be displayed on display 318 of computing device 300.

Also, although the various components are illustrated as separate components, in some examples the components may be combined to form a system on chip (SoC). As an example, camera processor 304, CPU 306, GPU 310, and display interface 316 may be formed on a common integrated circuit (IC) chip. In some examples, one or more of camera processor 304, CPU 306, GPU 310, and display interface 316 may be in separate IC chips. Various other permutations and combinations are possible, and the techniques should not be considered limited to the example illustrated in FIG. 1. The various components illustrated in FIG. 1 (whether formed on one device or different devices) may be formed as at least one of fixed-function or programmable circuitry such as in one or more microprocessors, application specific integrated circuits (ASICs), field programmable gate arrays (FPGAs), digital signal processors (DSPs), or other equivalent integrated or discrete logic circuitry.

The various units illustrated in FIG. 1 communicate with each other using bus 322. Bus 322 may be any of a variety of bus structures, such as a third generation bus (e.g., a HyperTransport bus or an InfiniBand bus), a second generation bus (e.g., an Advanced Graphics Port bus, a Peripheral Component Interconnect (PCI) Express bus, or an Advanced extensible Interface (AXI) bus) or another type of bus or device interconnect. It should be noted that the specific configuration of buses and communication interfaces between the different components shown in FIG. 3 is merely exemplary, and other configurations of computing devices and/or other image processing systems with the same or different components may be used to implement the techniques of this disclosure.

CPU 306 may comprise a general-purpose or a special-purpose processor that controls operation of computing device 300. A user may provide input to computing device 300 to cause CPU 306 to execute one or more software applications. The user may provide input to computing device 300 via one or more input devices (not shown) such as a keyboard, a mouse, a microphone, a touch pad or another input device that is coupled to computing device 300 via user interface 312.

One example of the software application is a camera application. CPU 306 executes the camera application, and in response, the camera application causes CPU 306 to generate content that display 318 outputs. For instance, display 318 may output information such as light intensity, whether flash is enabled, and other such information.

The user of computing device 300 may interface with display 318 to configure the manner in which the images are generated (e.g., with or without flash, focus settings, exposure settings, and other parameters).

GPU 310 may generate graphical information that provides the user information about the image frames to be captured. For instance, GPU 310 may generate a graphic that indicates whether flash is enabled, generate boxes around identified faces, etc.

Memory controller 314 facilitates the transfer of data going into and out of system memory 320. For example, memory controller 314 may receive memory read and write commands, and service such commands with respect to system memory 320 in order to provide memory services for the components in computing device 300. Memory controller 314 is communicatively coupled to system memory 320. Although memory controller 314 is illustrated in the example of computing device 300 of FIG. 3 as being a processing circuit that is separate from both CPU 306 and system memory 320, in other examples, some or all of the functionality of memory controller 314 may be implemented on one or both of CPU 306 and system memory 320.

System memory 320 may store program modules and/or instructions and/or data that are accessible by camera processor 304, CPU 306, and GPU 310. For example, system memory 320 may store user applications (e.g., instructions for the camera application), resulting images from camera processor 304, etc. System memory 320 may additionally store information for use by and/or generated by other components of computing device 300. For example, system memory 320 may act as a device memory for camera processor 304. System memory 320 may include one or more volatile or non-volatile memories or storage devices, such as, for example, random access memory (RAM), static RAM (SRAM), dynamic RAM (DRAM), read-only memory (ROM), erasable programmable ROM (EPROM), electrically erasable programmable ROM (EEPROM), flash memory, a magnetic data media or an optical storage media.

In some aspects, system memory 320 may include instructions that cause camera processor 304, CPU 306, GPU 310, and display interface 316 to perform the functions ascribed to these components in this disclosure. Accordingly, system memory 320 may be a computer-readable storage medium having instructions stored thereon that, when executed, cause one or more processors (e.g., camera processor 304, CPU 306, GPU 310, and display interface 316) to perform various functions.

In some examples, system memory 320 is a non-transitory storage medium. The term “non-transitory” indicates that the storage medium is not embodied in a carrier wave or a propagated signal. However, the term “non-transitory” should not be interpreted to mean that system memory 320 is non-movable or that its contents are static. As one example, system memory 320 may be removed from computing device 300, and moved to another device. As another example, memory, substantially similar to system memory 320, may be inserted into computing device 300. In certain examples, a non-transitory storage medium may store data that can, over time, change (e.g., in RAM).

Camera processor 304, CPU 306, and GPU 310 may store image data, and the like in respective buffers that are allocated within system memory 320. Display interface 316 may retrieve the data from system memory 320 and configure display 318 to display the image represented by the generated image data. In some examples, display interface 316 may include a digital-to-analog converter (DAC) that is configured to convert the digital values retrieved from system memory 320 into an analog signal consumable by display 318. In other examples, display interface 316 may pass the digital values directly to display 318 for processing.

Display 318 may include a monitor, a television, a projection device, a liquid crystal display (LCD), a plasma display panel, a light emitting diode (LED) array, or another type of display unit. Display 318 may be integrated within computing device 300. For instance, display 318 may be a screen of a mobile telephone handset or a tablet computer. Alternatively, display 318 may be a stand-alone device coupled to computing device 300 via a wired or wireless communications link. For instance, display 318 may be a computer monitor or flat panel display connected to a personal computer via a cable or wireless link.

In accordance with one or more examples described in this disclosure, the processing circuitry of computing device 300, which is an example of computing device 102, may be configured to perform the one or more examples techniques. The processing circuitry may be any one of or any combination of camera processor 304, CPU 306, GPU 310, or other circuitry of computing device 300.

For example, the processing circuitry may be configured to perform the operations during an initial period for a one-time preparation of initial factors that the processing circuitry may utilize later for generating depth information. During the initial period there may be no motion or less than a threshold amount of motion of the vehicle, and the processing circuitry may receive a first set of one or more images from first camera 302A. For example, first camera 302A may store the first set of one or more images in system memory 320 for access by the processing circuitry, or may directly output to the processing circuitry, such as camera processor 304.

If needed, the processing circuitry may perform image rectification. For example, the processing circuitry may rectify an image captured using a fisheye lens to be like an image that is captured using a flat lens, or vice-versa. This rectification allows for comparison between images from first camera 302A and second camera 302B. In some examples, this image rectification may be performed based on the images captured when a vehicle was not moving (e.g., zero-motion) or moving below some threshold.

The processing circuitry may determine capture timing information for each pixel in the first set of one or more images. The capture timing information may be different due to rolling shutter. For example, the capture timing information may indicate that a first set of pixels are captured at time 0 ms, a second set of pixels are captured at time 10 ms, and so forth relative to a synchronization time.

If needed, the processing circuitry may rectify timing information based on the image rectification described above. For instance, it may be possible for the processing circuitry to receive the timing information from camera 302A (e.g., row was captured at this time), but lens may distort the real-world image when the light gets to the sensor of camera 302A. This may also cause distortion in the timing information. The processing circuitry may use the timing information and the rectified image to determine the rectified timing information.

Based on the rectified timing information, the processing circuitry may determine a time difference between when pixels in an image from camera 302A and pixels in an image from camera 302B are captured. The processing circuitry may store the time difference information in system memory 320 for later access. In this disclosure, the processing circuitry determining a time difference may include the processing circuitry accessing time difference information from system memory 320 or determining at that instance, the time difference information.

As part of the initial period, the processing circuitry may determine optical flow information indicative of an amount of pixel rotational movement in images captured with the first camera 302A for a unit of rotational movement of the first camera 302A. The processing circuitry may also determine optical flow information indicative of an amount of pixel rotational movement in images captured with the second camera 302B for a unit of rotational movement of the second camera 302B. For example, the processing circuitry may determine how much rotation a pixel has in images captured with first camera 302A or second camera 302B for a unit of rotational movement (e.g., one degree). The processing circuitry may store the optical flow information for later access.

During real-time, for generating depth information, the processing circuitry may be configured to receive a first image captured with a first camera 302A and a second image captured with a second camera 302, the first camera 302A and the second camera 302B forming a camera pair for depth estimation. For example, first camera 302A and second camera 302B may store the first image and the second image, respectively, in system memory 320 for access by the processing circuitry, or may directly output to the processing circuitry, such as camera processor 304.

In one or more examples, the processing circuitry may determine a rotation component and a translation component of the first camera 302A. The processing circuitry may also determine a rotation component and a translation component of the second camera 302B. The processing circuitry may determine the rotation component and the translation component based on one or more of images captured with first camera 302A or one or more sensors 308 (e.g., while first camera 302A is in motion). For example, the processing circuitry may determine the rotation component and the translation component based on one or more of video odometry from the one or more images captured with first camera 302A or second camera 302B, speed and steering wheel angle of a vehicle that includes the first camera and the second camera determined based on the one or more sensors 308 (e.g., steering sensor 108 or speed sensor 110), or sensed motion determined based on the one or more sensors 308 (e.g., IMU 106)

In some examples, the rotation component of camera 302A may be the same as the rotation component of the IMU, where the IMU is one of one or more sensors 308. However, camera 302A and the IMU may be distant from each other, and therefore, the translation may be different. For instance, if the IMU is in the middle, but camera 302A is further away, on curve turn, camera 302A may translate more than the IMU. That is, the translation component of camera 302A and the IMU may differ.

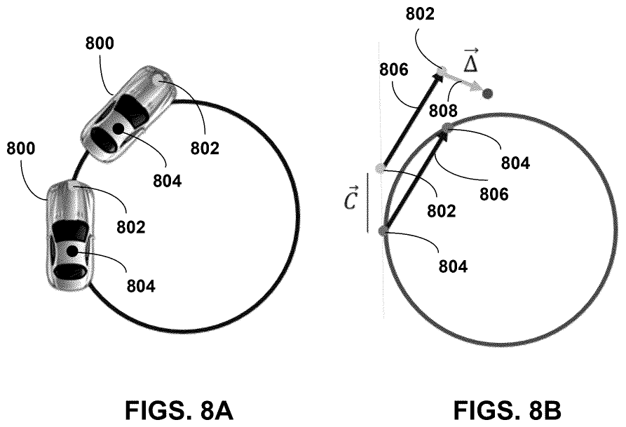

To compensate for this difference, the processing circuitry may use the rotation component along with the offset to determine a translation offset that the processing circuitry adds to the translation component from the IMU to determine the translation component of camera 104A and camera 104B. For example, FIG. 8A illustrates vehicle 800 moving in a circle, with camera 802 near the front of vehicle 800. The two instances of camera 802 illustrate the location of camera 802 at two different times, as vehicle 800 moves in a circle. Sensor 804 to determine the translation of vehicle 800 may be more central to vehicle 800 or near a rear-axel of vehicle 800. The two instances of sensor 804 illustrate the location of vehicle 800 at two different times, as vehicle 800 moves in a circle.

As illustrated in FIG. 8B, vehicle 800 translates by vector 806 then rotates. The rotation causes additional translation of camera 802 by vector 808. The rotation of camera 802 may differ with an offset based on if camera 802 is on right or left side of vehicle 800 (e.g., closer or farther from center of rotation). In FIG. 8B, C is the vector between sensor 804 and camera 802. In this example, vector 808 (also called Δ vector) is equal to R(C), which is the rotation of vehicle 800, minus C. That is, Δ vector=R(C)
C.

In one or more examples, the processing circuitry may be configured to separate out the movement information into a pure rotational component and a pure translation component. On a per-frame basis, the processing circuitry may use the rotational component and not use the translation component to generate rotation correct images. For example, the rotation component includes a rotational speed indicative of a speed at which the first camera 302A is rotating. To determine the corrected image (e.g., rotation corrected image) from the first image based on the rotation component of first camera 302A, the processing circuitry may be configured to determine a time difference between when pixels in the first image and the second image are captured, which may have been performed during the initial period.

The processing circuitry may access optical flow information indicative of an amount of pixel rotational movement in images captured with the first camera 302A for a unit of rotational movement of the first camera 302A. The processing circuitry may determine a rotational change based on the time difference, the rotational speed, and the optical flow information. For example, assume the rotational speed is 15-degrees/second, and the time difference between when pixels are captured is 0.1 seconds. In this case, multiplying 15-degrees/second and 0.1 seconds, results in 1.5 degrees. Multiplying 1.5 degrees with the optical flow information, which has units of how much a pixel rotates per degree of rotational movement, results in the rotational change. The rotational change being indicative of how much the pixels rotated due to the rolling shutter and the rotation of camera 302A.

The processing circuitry may rectify the first image based on the rotational change to determine the corrected image. For instance, the processing circuitry may move the pixels in the opposite direction by the rotational change to compensate for the rotation. There may be various ways in which to rectify the first image based on the rotational change, such as described in U.S. Patent Publication No 2024/0078684.

As additional examples, the processing circuitry may take the precomputed pixel movement due to a unit rotation (e.g., the access optical flow) and scale it by the amount of actual rotation. As another example, the processing circuitry can do the same 3D inverse projection, rotate by the amount specified and project to the camera plane.

The above example is described as being performed on the first image from first camera 302A. In one or more examples, the processing circuitry may perform the same techniques on the second image from the second camera 302B. However, it may be possible that some other technique is performed on the second image from second camera 302B.

That is, the processing circuitry may generate another image from the second image. The processing circuitry may generate this other image (i.e., the another image) from the second image using similar techniques as those used to generate the corrected image from the first image. However, it may be possible to use another technique to generate the other image.

For instance, the processing circuitry may generate depth information based on pixels in the corrected image and corresponding pixels in the other image and the translation component. As one example, the processing circuitry may determine disparity information based on the pixels in the corrected image and the corresponding pixels in the other image. To generate depth information, the processing circuitry may be configured to generate the depth information based on the disparity information and the translation component.

For corresponding pixels, the processing circuitry may utilize any known technique used for pixel corresponding, and the techniques are not limited to any particular pixel corresponding technique. To generate the depth information based on the disparity information and the translation component, the processing circuitry may be configured to determine a time difference between when pixels in the first image and the second image are captured, as described above. The processing circuitry may also determine a camera baseline between the first camera 302A and the second camera 302B based on the time difference and the translation component. The processing circuitry may generate the depth information based on the disparity information and the camera baseline.

One example manner to determine the camera baseline is based on the actual distance between the first camera 302A and second camera 302B plus a baseline offset. In one or more examples, the processing circuitry may determine the baseline offset by multiplying the translation speed and time difference. For instance, the units of the translation speed may be distance/second, and the units of the time difference may be seconds, and therefore, by multiplying the resulting units are that of distance, and represent a baseline offset.

FIG. 4 is a flowchart illustrating a method of image processing according to one or more example techniques described in this disclosure. FIG. 4 illustrates an example of the processing circuitry performing the one-time preparation. The processing circuitry may synchronize cameras (400). For instance, the processing circuitry may cause first camera 104A or 302A and second camera 104B or 302B to being capturing image content starting from a horizon or from a center of the images.

The processing circuitry may be configured to perform image rectification (402). In image rectification, the processing circuitry may rectify an image captured with a fisheye lens so that the image is in the image domain (e.g., flat) as the image captured with a flat lens. It should be understood that fisheye lens and flat lens are provided for illustration purposes only, and should not be considered limiting. In some examples, the image rectification may be performed when a vehicle is not moving (e.g., zero-motion or motion below a threshold).

The processing circuitry may determine rolling shutter timing (404). For instance, the processing circuitry may determine when pixels in the images from first camera 104A or 302A and second camera 104B or 302B are captured. The processing circuitry may determine a time difference between when the pixels are captured based on the determination of when pixels in the images from first camera 104A or 302A and second camera 104B or 302B are captured. In some examples, the processing circuitry may store the time information for later use.

The processing circuitry may rectify timing information based on the image rectification (406). For instance, due to the lens of a camera, it is possible that light bends and the pixels that capture that light do not correspond well with pixels in the image of the other camera. The processing circuitry may utilize the rectified images and the time when pixels are captured to rectify the time information. Similar to above description, the processing circuitry may construct a frame of the timing information, offset from the top or other synchronization point, and then apply the same geometric rectification (e.g., zero-motion rectification) to the timing information image so the timing data is associated to a pixel when rectified or warped.

The processing circuitry may determine optical flow information based on unit rotation (408). For example, the processing circuitry may determine how much a pixel in an image moves for a unit rotation of camera 104A, 302A 104B, or 302B. In some examples, this can be performed using approximations. For example, the processing circuitry may determine optical flow information offline by starting with a pixel, projecting that into a point in three-dimensional space at any specific distance, rotate the camera one unit and then project back to the camera image to determine where the pixel moves to. For these pure rotations, the resulting pixel motion is the same regardless of the distance in 3D used. A large value of say 100 meter may be used as an example. In some examples, the processing circuitry may use the determined amount a pixel moves due to a unit rotation (e.g., optical flow) and scale that by the amount of actual rotation given by rotation rate (degrees per second) multiplied by the time difference in seconds, as described in more detail for compensating for rotation.

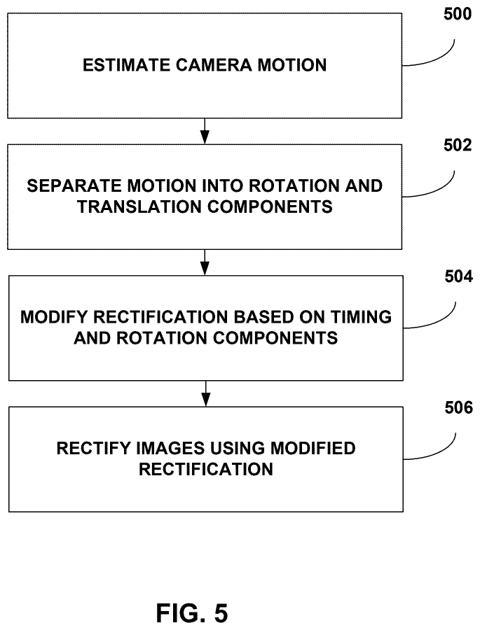

FIG. 5 is a flowchart illustrating another method of image processing according to one or more example techniques described in this disclosure. The example of FIG. 5 illustrates a per-frame operation. The processing circuitry may estimate camera motion (500), and separate the motion into rotation and translation components (502). For instance, the processing circuitry may utilize video odometry, speed and steering wheel angle of a vehicle that includes the first camera and the second camera, or sensed motion to determine the rotation and translation component. The rotation component may also include a rotation speed, and the translation component may also include a translation speed.

The processing circuitry may modify rectification based on timing and rotation components (504). In this example, the processing circuitry may use the rotation component to remove the rotation of the image. In general, the rotation of an image modifies the image, but does not depend on depth. That is, the rotation of the camera gives the same modification to a pixel independent of depth of the corresponding point in 3D. To remove rotation, the processing circuitry may utilize the time difference of when the pixels in images from first camera 104A, 302A and second camera 104B, 302B are captured, and the optical flow information (e.g., how much did pixel move if vehicle moved by one unit). For instance, the processing circuitry may generate a corrected image (e.g., rotation corrected image) based on the rotation component.

The processing circuitry may rectify image using modified rectification (506). For example, the processing circuitry may rotate the image content in the opposite direction based on how much rotational change there was as determined during the generation of the corrected image. For instance, the processing circuitry may determine a rotational change based on the time difference, the rotational speed, and the optical flow information (e.g., multiplication of the time difference between when pixels are captured, the rotational speed, and the optical flow information). The processing circuitry may rectify the first image based on the rotational change to determine the corrected image.

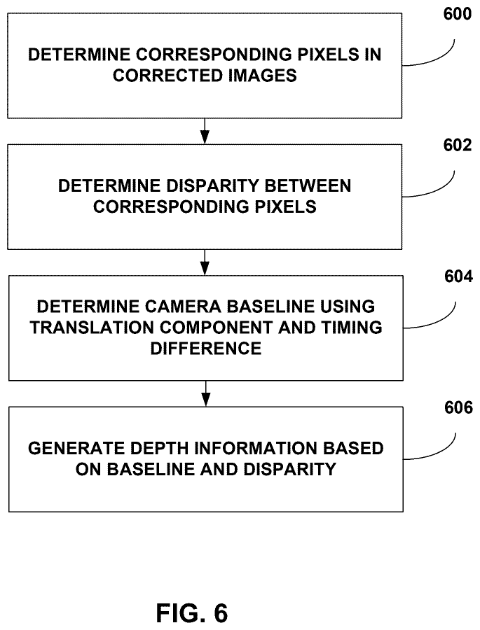

FIG. 6 is a flowchart illustrating another method of image processing according to one or more example techniques described in this disclosure. The example of FIG. 6 illustrates a per-pixel operation. The processing circuitry may determine corresponding pixels in the corrected images (e.g., rotation corrected image) (600). The processing circuitry may use various known techniques to determine corresponding pixels. The processing circuitry may determine disparity between corresponding pixels (602). For example, the processing circuitry may determine the coordinates of a pixel in a first corrected image and the coordinates of a corresponding pixel in a second corrected image. The processing circuitry may subtract the coordinates to determine the disparity.

The processing circuitry may determine a camera baseline using the translation component and timing difference (604). For example, the processing circuitry may determine an actual distance between the first camera and the second camera, determine a baseline offset based on the time difference and a translation speed of the translation component, and add the baseline offset to the actual distance to determine the camera baseline.

The processing circuitry may generate depth information based on the disparity information and the camera baseline (606). For instance, the processing circuitry may divide the disparity by the camera baseline and multiply result by the focal length. In this way, the images used for determining corresponding pixels are based on the corrected image, and the camera baseline is updated to account for the translation. Accordingly, the resulting depth information may be more accurate compared to other techniques.

In one or more examples, the focal length of the cameras 302A, 302B may be the same. To determine the depth information, it may be possible to determine the depth information relative to one of cameras 302A, 302B. That is, the processing circuitry may determine the camera baseline relative to camera 302A, if the distance is to be determined relative to camera 302A. The processing circuitry may divide the disparity by the camera baseline of camera 302A and multiply the result by the focal length of camera 302A.

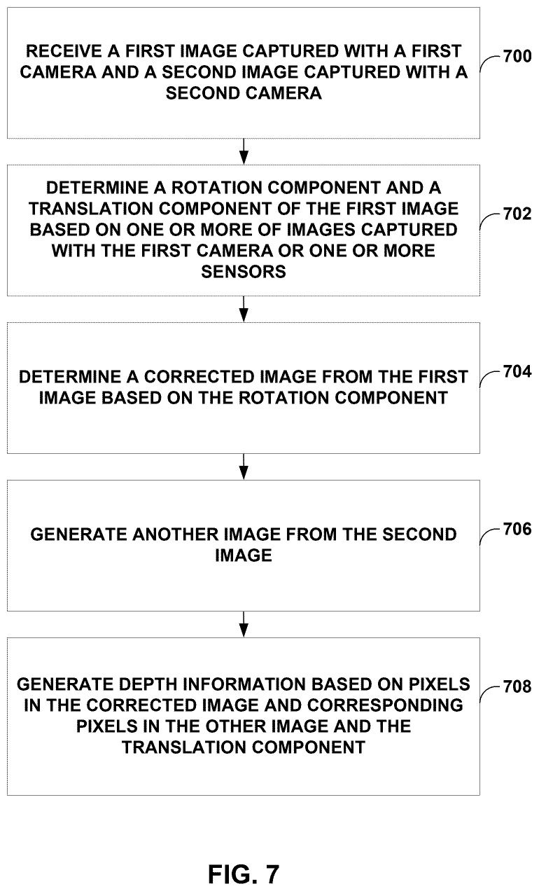

FIG. 7 is a flowchart illustrating another method of image processing according to one or more example techniques described in this disclosure. The processing circuitry may receive a first image captured with a first camera and a second image captured with a second camera, the first camera and the second camera forming a camera pair for depth estimation (700). This may be part of the depth generation process.

The processing circuitry may determine a rotation component and a translation component of the first camera based on one or more of images captured with the first camera or one or more sensors (702), such as while the first camera is in motion. For example, the processing circuitry may determine a rotation component and a translation component based on video odometry from the one or more images captured with the first camera, speed and steering wheel angle of a vehicle determined based on the one or more sensors, or sensed motion determined based on the one or more sensors together with location of the camera on the vehicle.

The processing circuitry may determine a corrected image from the first image based on the rotation component (704). For example, the rotation component includes a rotational speed indicative of a speed at which the first camera is rotating. To determine the corrected image from the first image based on the rotation component, the processing circuitry may be configured to determine a time difference between when pixels in the first image and the second image are captured, access optical flow information indicative of an amount of pixel rotational movement in images captured with the first camera for a unit of rotational movement of the first camera, determine a rotational change based on the time difference, the rotational speed, and the optical flow information, and rectify the first image based on the rotational change to determine the corrected image. In some examples, to determine the corrected image, the processing circuitry may be configured to determine the corrected image from the first image based on the rotation component and without the translation component.

The processing circuitry may generate another image from the second image (706). Although the techniques are not so limited, in some examples, this other image (e.g., the another image) may be generated in the same way as the corrected image. For example, the rotation component may be a first rotation component and the translation component is a first translation component. The corrected image is a first corrected image. The processing circuitry may be configured to determine a second rotation component and a second translation component of the second camera, and determine a second corrected image from the second image based on the second rotation component. The second corrected image may be the other image. In some examples, the other image may be the same as the second image, and the generating of the other image may be copying or reusing the second image.

The processing circuitry may generate depth information based on pixels in the corrected image and corresponding pixels in the other image and the translation component (708). For example, the processing circuitry may be configured to determine disparity information based on the pixels in the corrected image and the corresponding pixels in the other image. To generate depth information, the processing circuitry may be configured to generate the depth information based on the disparity information and the translation component.

In some examples, to generate the depth information, the processing circuitry is configured to generate the depth information based on the disparity information and the translation component and without the rotation component. To generate the depth information, the processing circuitry may be configured to generate the depth information based on the disparity information, the first translation component, and the second translation component.

In one or more examples, to generate the depth information, the processing circuitry may be configured to determine a time difference between when pixels in the first image and the second image are captured, determine a camera baseline between the first camera and the second camera based on the time difference and the translation component, and generate the depth information based on the camera baseline, and the disparity information in some examples. For example, to determine the camera baseline between the first camera and the second camera based on the time difference and the translation component, the processing circuitry may be configured to determine a baseline offset based on the time difference and a translation speed of the translation component, and add the baseline offset to an actual distance between the first camera and the second camera to determine the camera baseline.

The processing circuitry may perform various operations based on the depth information. For example, the processing circuitry may be configured to determine an operating parameter based on the depth information. The operating parameter may include an operating parameter of a vehicle that includes the first camera and the second camera. Examples of the operating parameter may be a braking parameter or a path parameter. There may be other examples of operating parameters, such as turning the vehicle. There may be other operations that the processing circuitry may perform such as scene analysis, determining whether an object is moving or not, etc.

As one example, the processing circuitry may determine a braking parameter such as whether to automatically cause vehicle 100 to brake because the depth information indicates that an object is close by. As another example, the processing circuitry may determine a path parameter that indicates a path vehicle 100 should take based on the depth information. For instance, the processing circuitry may navigate a path based on how close objects are as determined from the depth information. There may be other operations as well.

The following describes one or more examples in accordance with the techniques described in this disclosure.

Clause 1. A device for image processing, comprising: one or more memories; and processing circuitry coupled to the one or more memories, wherein the processing circuitry is configured to: receive a first image captured with a first camera and a second image captured with a second camera; determine a rotation component and a translation component of the first camera based on one or more of images captured with the first camera or one or more sensors; determine a corrected image from the first image based on the rotation component; generate another image from the second image; and generate depth information based on pixels in the corrected image and corresponding pixels in the other image and the translation component.

Clause 2. The device of clause 1, wherein the rotation component is a first rotation component and the translation component is a first translation component, wherein the corrected image is a first corrected image, wherein the processing circuitry is configured to determine a second rotation component, and wherein to generate the other image from the second image, the processing circuitry is configured to determine a second corrected image from the second image based on the second rotation component, wherein the second corrected image is the other image generated from the second image.

Clause 3. The device of any of clauses 1 and 2, wherein the rotation component includes a rotational speed indicative of a speed at which the first camera is rotating, and wherein to determine the corrected image from the first image based on the rotation component, the processing circuitry is configured to: determine a time difference between when pixels in the first image and the second image are captured; access optical flow information indicative of an amount of pixel rotational movement in images captured with the first camera for a unit of rotational movement of the first camera; determine a rotational change based on the time difference, the rotational speed, and the optical flow information; and rectify the first image based on the rotational change to determine the corrected image.

Clause 4. The device of any of clauses 1-3, wherein to generate the depth information, the processing circuitry is configured to: determine a time difference between when pixels in the first image and the second image are captured; determine a camera baseline between the first camera and the second camera based on the time difference and the translation component; and generate the depth information based on the camera baseline.

Clause 5. The device of clause 4, wherein to determine the camera baseline between the first camera and the second camera based on the time difference and the translation component, the processing circuitry is configured to: determine a baseline offset based on the time difference and a translation speed of the translation component; and add the baseline offset to an actual distance between the first camera and the second camera to determine the camera baseline.

Clause 6. The device of any of clauses 1-5, wherein to determine the rotation component and the translation component, the processing circuitry is configured to determine the rotation component and the translation component based on one or more of: video odometry from the one or more images captured with the first camera; speed and steering wheel angle of a vehicle that includes the first camera and the second camera determined based on the one or more sensors; or sensed motion determined based on the one or more sensors.

Clause 7. The device of any of clauses 1-6, wherein to determine the corrected image, the processing circuitry is configured to determine the corrected image from the first image based on the rotation component and without the translation component.

Clause 8. The device of any of clauses 1-7, wherein to generate the depth information, the processing circuitry is configured to generate the depth information based on the translation component and without the rotation component.

Clause 9. The device of any of clauses 1-8, wherein the processing circuitry is configured to determine disparity information based on the pixels in the corrected image and the corresponding pixels in the other image, and wherein to generate depth information, the processing circuitry is configured to generate the depth information based on the disparity information and the translation component.

Clause 10. The device of any of clauses 1-9, wherein the device comprises a vehicle that includes the first camera and the second camera.

Clause 11. The device of any of clauses 1-10, wherein the processing circuitry is configured to determine an operating parameter based on the depth information.

Clause 12. The device of clause 11, wherein the operating parameter includes an operating parameter of a vehicle that includes the first camera and the second camera, and the operating parameter comprises one or more a braking parameter or a path parameter of the vehicle.

Clause 13. A method of image processing, the method comprising: receiving a first image captured with a first camera and a second image captured with a second camera; determining a rotation component and a translation component of the first camera based on one or more of images captured with the first camera or one or more sensors; determining a corrected image from the first image based on the rotation component; generating another image from the second image; and generating depth information based on pixels in the corrected image and corresponding pixels in the other image and the translation component.

Clause 14. The method of clause 13, wherein the rotation component is a first rotation component and the translation component is a first translation component, wherein the corrected image is a first corrected image, the method further comprising determining a second rotation component, and wherein generating the other image from the second image comprises determining a second corrected image from the second image based on the second rotation component, wherein the second corrected image is the other image generated from the second image.

Clause 15. The method of any of clauses 13 and 14, wherein the rotation component includes a rotational speed indicative of a speed at which the first camera is rotating, and wherein determining the corrected image from the first image based on the rotation component comprises: determining a time difference between when pixels in the first image and the second image are captured; accessing optical flow information indicative of an amount of pixel rotational movement in images captured with the first camera for a unit of rotational movement of the first camera; determining a rotational change based on the time difference, the rotational speed, and the optical flow information; and rectifying the first image based on the rotational change to determine the corrected image.

Clause 16. The method of any of clauses 13-15, wherein generating the depth information comprises: determining a time difference between when pixels in the first image and the second image are captured; determining a camera baseline between the first camera and the second camera based on the time difference and the translation component; and generating the depth information based on the camera baseline.

Clause 17. The method of clause 16, wherein determining the camera baseline between the first camera and the second camera based on the time difference and the translation component comprises: determining a baseline offset based on the time difference and a translation speed of the translation component; and adding the baseline offset to an actual distance between the first camera and the second camera to determine the camera baseline.

Clause 18. The method of any of clauses 13-17, wherein determining the rotation component and the translation component comprises determining the rotation component and the translation component based on one or more of: video odometry from the one or more images captured with the first camera; speed and steering wheel angle of a vehicle that includes the first camera and the second camera determined based on the one or more sensors; or sensed motion determined based on the one or more sensors.

Clause 19. The method of any of clauses 13-18, further comprising determining an operating parameter based on the depth information.

Clause 20. One or more computer-readable storage media storing instructions thereon that when executed cause one or more processors to: receive a first image captured with a first camera and a second image captured with a second camera; determine a rotation component and a translation component of the first camera based on one or more of images captured with the first camera or one or more sensors; determine a corrected image from the first image based on the rotation component; generate another image from the second image; and generate depth information based on pixels in the corrected image and corresponding pixels in the other image and the translation component.

In one or more examples, the functions described may be implemented in hardware, software, firmware, or any combination thereof. If implemented in software, the functions may be stored on or transmitted over, as one or more instructions or code, a computer-readable medium and executed by a hardware-based processing unit. Computer-readable media may include computer-readable storage media, which corresponds to a tangible medium such as data storage media. In this manner, computer-readable media generally may correspond to tangible computer-readable storage media which is non-transitory. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. It should be understood that computer-readable storage media and data storage media do not include carrier waves, signals, or other transient media, but are instead directed to non-transient, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples have been described. These and other examples are within the scope of the following claims.

What is claimed is:

1. A device for image processing, comprising:
one or more memories; and
processing circuitry coupled to the one or more memories, wherein the processing circuitry is configured to:
receive a first image captured with a first camera and a second image captured with a second camera;
determine a rotation component and a translation component of the first camera based on one or more of images captured with the first camera or one or more sensors;
determine a corrected image from the first image based on the rotation component;
generate another image from the second image; and
generate depth information based on pixels in the corrected image and corresponding pixels in the other image and the translation component.

2. The device of claim 1, wherein the rotation component is a first rotation component and the translation component is a first translation component, wherein the corrected image is a first corrected image, wherein the processing circuitry is configured to determine a second rotation component, and wherein to generate the other image from the second image, the processing circuitry is configured to determine a second corrected image from the second image based on the second rotation component, wherein the second corrected image is the other image generated from the second image.

3. The device of claim 1, wherein the rotation component includes a rotational speed indicative of a speed at which the first camera is rotating, and wherein to determine the corrected image from the first image based on the rotation component, the processing circuitry is configured to:
determine a time difference between when pixels in the first image and the second image are captured;
access optical flow information indicative of an amount of pixel rotational movement in images captured with the first camera for a unit of rotational movement of the first camera;
determine a rotational change based on the time difference, the rotational speed, and the optical flow information; and
rectify the first image based on the rotational change to determine the corrected image.

4. The device of claim 1, wherein to generate the depth information, the processing circuitry is configured to:
determine a time difference between when pixels in the first image and the second image are captured;
determine a camera baseline between the first camera and the second camera based on the time difference and the translation component; and
generate the depth information based on the camera baseline.

5. The device of claim 4, wherein to determine the camera baseline between the first camera and the second camera based on the time difference and the translation component, the processing circuitry is configured to:
determine a baseline offset based on the time difference and a translation speed of the translation component; and
add the baseline offset to an actual distance between the first camera and the second camera to determine the camera baseline.

6. The device of claim 1, wherein to determine the rotation component and the translation component, the processing circuitry is configured to determine the rotation component and the translation component based on one or more of:
video odometry from the one or more images captured with the first camera;
speed and steering wheel angle of a vehicle that includes the first camera and the second camera determined based on the one or more sensors; or
sensed motion determined based on the one or more sensors.

7. The device of claim 1, wherein to determine the corrected image, the processing circuitry is configured to determine the corrected image from the first image based on the rotation component and without the translation component.

8. The device of claim 1, wherein to generate the depth information, the processing circuitry is configured to generate the depth information based on the translation component and without the rotation component.

9. The device of claim 1, wherein the processing circuitry is configured to determine disparity information based on the pixels in the corrected image and the corresponding pixels in the other image, and wherein to generate depth information, the processing circuitry is configured to generate the depth information based on the disparity information and the translation component.

10. The device of claim 1, wherein the device comprises a vehicle that includes the first camera and the second camera.

11. The device of claim 1, wherein the processing circuitry is configured to determine an operating parameter based on the depth information.

12. The device of claim 11, wherein the operating parameter includes an operating parameter of a vehicle that includes the first camera and the second camera, and the operating parameter comprises one or more a braking parameter or a path parameter of the vehicle.

13. A method of image processing, the method comprising:
receiving a first image captured with a first camera and a second image captured with a second camera;
determining a rotation component and a translation component of the first camera based on one or more of images captured with the first camera or one or more sensors;
determining a corrected image from the first image based on the rotation component;
generating another image from the second image; and
generating depth information based on pixels in the corrected image and corresponding pixels in the other image and the translation component.

14. The method of claim 13, wherein the rotation component is a first rotation component and the translation component is a first translation component, wherein the corrected image is a first corrected image, the method further comprising determining a second rotation component, and wherein generating the other image from the second image comprises determining a second corrected image from the second image based on the second rotation component, wherein the second corrected image is the other image generated from the second image.

15. The method of claim 13, wherein the rotation component includes a rotational speed indicative of a speed at which the first camera is rotating, and wherein determining the corrected image from the first image based on the rotation component comprises:
determining a time difference between when pixels in the first image and the second image are captured;
accessing optical flow information indicative of an amount of pixel rotational movement in images captured with the first camera for a unit of rotational movement of the first camera;
determining a rotational change based on the time difference, the rotational speed, and the optical flow information; and
rectifying the first image based on the rotational change to determine the corrected image.

16. The method of claim 13, wherein generating the depth information comprises:
determining a time difference between when pixels in the first image and the second image are captured;
determining a camera baseline between the first camera and the second camera based on the time difference and the translation component; and
generating the depth information based on the camera baseline.

17. The method of claim 16, wherein determining the camera baseline between the first camera and the second camera based on the time difference and the translation component comprises:
determining a baseline offset based on the time difference and a translation speed of the translation component; and
adding the baseline offset to an actual distance between the first camera and the second camera to determine the camera baseline.

18. The method of claim 13, wherein determining the rotation component and the translation component comprises determining the rotation component and the translation component based on one or more of:
video odometry from the one or more images captured with the first camera;
speed and steering wheel angle of a vehicle that includes the first camera and the second camera determined based on the one or more sensors; or
sensed motion determined based on the one or more sensors.

19. The method of claim 13, further comprising determining an operating parameter based on the depth information.

20. One or more computer-readable storage media storing instructions thereon that when executed cause one or more processors to:
receive a first image captured with a first camera and a second image captured with a second camera;
determine a rotation component and a translation component of the first camera based on one or more of images captured with the first camera or one or more sensors;
determine a corrected image from the first image based on the rotation component;
generate another image from the second image; and
generate depth information based on pixels in the corrected image and corresponding pixels in the other image and the translation component.
